(19) United States
(12) Patent Application Publication
(10) Pub. No.: US 2022/0067516 A1
(43) Pub. Date: Mar. 3, 2022

(54) EVALUATION METRIC VALUE COMPUTATION DEVICE AND EVALUATION METRIC VALUE COMPUTATION METHOD

(71) Applicant: NEC Corporation, Tokyo (JP)

(72) Inventor: Takashi MARUYAMA, Tokyo (JP)

(73) Assignee: NEC Corporation, Tokyo (JP)

(21) Appl. No.: 17/402,850

(22) Filed: Aug. 16, 2021

(30) Foreign Application Priority Data
Aug. 25, 2020 (JP) 2020-141565

(51) Int. Cl. G06N 3/08

(52) U.S. Cl. CPC G06N 3/08

(57) ABSTRACT

The evaluation metric value computation device 20 includes a computation unit 21 which computes one or more values of evaluation metrics in one or more ranges in which each of the evaluation metrics may be specified in a graph using a predetermined function corresponding to a type of each of the evaluation metrics, for each range, when the graph in which the evaluation metric is specified at least in part is input, and a selection unit 22 which selects one or more values corresponding to the range in which the evaluation metric is specified in the graph from among computed one or more values of evaluation metrics.

This application is based upon and claims the benefit of priority from Japanese patent application No. 2020-141565, filed on Aug. 25, 2020, the disclosure of which is incorporated here in its entirety by reference.

### BACKGROUND

### Technical Field

The present invention relates to an evaluation metric value computation device, an evaluation metric value computation method, and a recording medium storing an evaluation metric value computation program.

### Related Art

Multi-objective reinforcement learning, which is a field of machine learning, is applied to problems of optimizing a graph structure representing information, such as molecular compounds and ICT (Information and Communication Technology) systems. The main objective of multi-objective reinforcement learning is to learn a cost function model that enables a search to satisfy multiple evaluation metrics.

In the above problems, especially the problem where the search state is represented by a graph, the evaluation metric represents a type of feature computed from the graph structure. The evaluation metric may be associated with a part of the graph or for the whole graph.

In general, several different functions are associated with each evaluation metric. In other words, both the input value to the function and the output value from the function are different for each type of evaluation metric.

FIG. 8 is an explanatory diagram showing an example of an evaluation metric defined for an entire graph representing a molecular compound and a function corresponding to the evaluation metric. FIG. 8 shows an example of an evaluation metric. In the example shown in FIG. 8, QED (Quantitative Estimate of Drug-likeness), which represents drug-likeness, is employed as the evaluation metric.

A graph enclosed by a broken line shown in FIG. 8 represents an example of a molecular compound. The function f_{QED} shown in FIG. 8 receives the graph shown in FIG. 8 as an input and performs numerical computing operation targeted at the input graph. In the example shown in FIG. 8, the function f_{QED} outputs a numerical value s as a result of the numerical computing operation targeted at the graph.

J. You, B. Liu, R. Ying, V. Pande, and J. Leskovec, “Graph Convolutional Policy Network for Goal-Directed Molecular Graph Generation,” Neural Information Processing Systems, 2018. describes a method for performing multi-objective reinforcement learning targeted at a graph representing a molecular compound, as shown in FIG. 8, to search for a molecular structure that optimizes multiple evaluation metrics. The values of the evaluation metrics used in the method described in J. You, B. Liu, R. Ying, V. Pande, and J. Leskovec, “Graph Convolutional Policy Network for Goal-Directed Molecular Graph Generation,” Neural Information Processing Systems, 2018. are values computed from a structure of the molecular compound, such as drug-likeness, molecular weight. Each evaluation metric is assigned as an index for the entire graph structure.

In the method described in J. You, B. Liu, R. Ying, V. Pande, and J. Leskovec, “Graph Convolutional Policy Network for Goal-Directed Molecular Graph Generation,” Neural Information Processing Systems, 2018., a single scalar value to which the values of the above multiple evaluation metrics are converted is used as a teacher label to train a cost function model for search.

FIG. 9 is an explanatory diagram showing an example of an evaluation metric defined for an entire graph representing an ICT system and a function corresponding to the evaluation metric. FIG. 9 shows an example of an evaluation metric.

The graph enclosed by a broken line shown in FIG. 9 represents an example of an ICT system. The graph shown in FIG. 9 represents a functional structure of the system.

Specifically, vertexes of the graph shown in FIG. 9 represents an IT/NW (Information Technology/Network) devices such as an application, middleware, server, router, firewall, respectively. In addition, edges of the graph shown in FIG. 9 represents the connection relationships between IT/NW devices, such as HTTP (Hypertext Transfer Protocol) communication, TCP (Transmission Control Protocol) communication, IP (Internet Protocol) communication, and Ethernet (registered trademark) communication, respectively.

In the example shown in FIG. 9, the cost defined for the ICT system is the evaluation metric. The function f_{cost} shown in FIG. 9 is a function that computes the defined cost from a graph. In the example shown in FIG. 9, the function f_{cost} outputs the cost s computed from the graph.

FIG. 10 is an explanatory diagram showing an example of an evaluation metric defined for a part of a graph representing an ICT system and a function corresponding to the evaluation metric. FIG. 10 shows an example of an evaluation metric.

The graph enclosed by a broken line shown in FIG. 10 represents an example of an ICT system. The graph shown in FIG. 10 is identical to the graph enclosed by the broken line shown in FIG. 9.

The function f_{bandwidth} shown in FIG. 10 is a function that receives as input the graph shown by a broken frame in FIG. 10 and the edges within a candidate of a specified range shown by a broken frame inside the graph in FIG. 10, and computes a bandwidth of the received edges. The candidate of the specified range shown in FIG. 10 is a range in which the evaluation metric may be specified.

In other words, in the example shown in FIG. 10, the bandwidth defined for a particular edge is an evaluation metric. In addition, the function f_{bandwidth} is a function that computes the bandwidth defined for an edge. In the example shown in FIG. 10, the function f_{bandwidth} outputs the bandwidth s computed from the edges within the candidate of the specified range.

In addition, the candidate of the specified range is not limited to the range enclosing the edges of the graph shown in FIG. 10. The candidate of the specified range may be a range enclosing the vertices of the graph, a wider range than the range enclosing the subgraph, etc.

T. Maruyama, T. Kuwahara, Y. Yakuwa, T. Kuroda, and Y Sato, “Accelerated Search for Search-Based Network Design Generation Scheme with Reinforcement Learning,” IEICE Technical Report, vol. 118, no. 483, ICM2018-71, pp. 123-128, March 2019. describes a method for deriving a system configuration that optimizes an evaluation metric by performing reinforcement learning on a graph representing an ICT system as shown in FIGS. 9 and 10. The evaluation metric used in the method described in T. Maruyama, T. Kuwahara, Y Yakuwa, T. Kuroda, and Y. Sato, “Accelerated Search for Search-Based Network Design Generation Scheme with Reinforcement Learning,” IEICE Technical Report, vol. 118, no. 483, ICM2018-71, pp. 123-128, March 2019. is a functional requirement.

Functional requirement is a requirement for the function required of the system. Functional requirement includes, “to analyze a video captured by a camera using analysis software” or “to monitor a result of the analysis”, for example.

The method described in T. Maruyama, T. Kuwahara, Y Yakuwa, T. Kuroda, and Y Sato, “Accelerated Search for Search-Based Network Design Generation Scheme with Reinforcement Learning,” IEICE Technical Report, vol. 118, no. 483, ICM2018-71, pp. 123-128, March 2019. derives a system configuration that satisfies an input functional requirement by searching for a system configuration that optimizes an evaluation metric. Whether or not the functional requirement is satisfied is expressed by a numerical value of 0 or 1, respectively.

### SUMMARY

The types of evaluation metrics used in the search methods described in the above J. You, B. Liu, R. Ying, V. Pande, and J. Leskovec, “Graph Convolutional Policy Network for Goal-Directed Molecular Graph Generation,” Neural Information Processing Systems, 2018. and T. Maruyama, T. Kuwahara, Y Yakuwa, T. Kuroda, and Y Sato, “Accelerated Search for Search-Based Network Design Generation Scheme with Reinforcement Learning,” IEICE Technical Report, vol. 118, no. 483, ICM2018-71, pp. 123-128, March 2019. are not changed in each search. In addition, the search model used in the search methods described in J. You, B. Liu, R. Ying, V. Pande, and J. Leskovec, “Graph Convolutional Policy Network for Goal-Directed Molecular Graph Generation,” Neural Information Processing Systems, 2018. and T. Maruyama, T. Kuwahara, Y. Yakuwa, T. Kuroda, and Y. Sato, “Accelerated Search for Search-Based Network Design Generation Scheme with Reinforcement Learning,” IEICE Technical Report, vol. 118, no. 483, ICM2018-71, pp. 123-128, March 2019. is learned to directly output a scalar value into which multiple evaluation metrics are merged.

Therefore, even if the evaluation metric to be optimized at the time of search is different from the evaluation metric used to compute the value of training data at the time of learning, the model for search computes the prediction value of the scalar value into which the evaluation metrics used at the time of learning are merged, when search is performed.

The search models used in the search methods described in J. You, B. Liu, R. Ying, V. Pande, and J. Leskovec, “Graph Convolutional Policy Network for Goal-Directed Molecular Graph Generation,” Neural Information Processing Systems, 2018. and T. Maruyama, T. Kuwahara, Y. Yakuwa, T. Kuroda, and Y. Sato, “Accelerated Search for Search-Based Network Design Generation Scheme with Reinforcement Learning,” IEICE Technical Report, vol. 118, no. 483, ICM2018-71, pp. 123-128, March 2019. are models that are used on the assumption that the specified range, which is the range in which the evaluation metric is specified for the search state, is fixed within the range enclosing the entire graph.

Therefore, the above search model cannot handle evaluation metrics that are specified as a part of the graph. The reason is that the search model is not configured to allow the input of a specified range that encloses a part of the graph.

As a result of the above, the search methods described in J. You, B. Liu, R. Ying, V. Pande, and J. Leskovec, “Graph Convolutional Policy Network for Goal-Directed Molecular Graph Generation,” Neural Information Processing Systems, 2018. and T. Maruyama, T. Kuwahara, Y. Yakuwa, T. Kuroda, and Y. Sato, “Accelerated Search for Search-Based Network Design Generation Scheme with Reinforcement Learning,” IEICE Technical Report, vol. 118, no. 483, ICM2018-71, pp. 123-128, March 2019. are difficult to search depending on a type of an evaluation metric specified during the search and the specified range enclosing a part of the graph.

Therefore, one of the purposes of the present disclosure is to provide an evaluation metric value computation device, an evaluation metric value computation method, and a recording medium storing an evaluation metric value computation program that can output a comprehensive evaluation value depending on a range of a search state in which evaluation metrics are specified and a type of evaluation metric.

In an example embodiment of the present disclosure, an evaluation metric value computation device includes at least one processor and a memory coupled to the at least one processor, wherein the at least one processor is configured to one or more instruction to compute one or more values of evaluation metrics in one or more ranges in which each of the evaluation metrics may be specified in a graph using a predetermined function corresponding to a type of each of the evaluation metrics, for each range, when the graph in which the evaluation metric is specified at least in part is input, and select one or more values corresponding to the range in which the evaluation metric is specified in the graph from among computed one or more values of evaluation metrics.

In an example embodiment of the present disclosure, an evaluation metric value computation method includes computing one or more values of evaluation metrics in one or more ranges in which each of the evaluation metrics may be specified in a graph using a predetermined function corresponding to a type of each of the evaluation metrics, for each range, when the graph in which the evaluation metric is specified at least in part is input, and selecting one or more values corresponding to the range in which the evaluation metric is specified in the graph from among computed one or more values of evaluation metrics.

In an example embodiment of the present disclosure, a non-transitory computer readable information recording medium storing an evaluation metric value computation program, when executed by a computer, performs computing one or more values of evaluation metrics in one or more ranges in which each of the evaluation metrics may be specified in a graph using a predetermined function corresponding to a type of each of the evaluation metrics, for each range, when the graph in which the evaluation metric is specified at least in part is input, and selecting one or more values corresponding to the range in which the evaluation metric is specified in the graph from among computed one or more values of evaluation metrics.

According to the present disclosure, a comprehensive evaluation value can be output depending on a range of a search state in which evaluation metrics are specified and a type of evaluation metric.

### BRIEF DESCRIPTION OF DRAWINGS

FIG. 1 is a block diagram showing an example of the configuration of an evaluation metric value computation device of an example embodiment of the present disclosure;

FIG. 2 is an explanatory diagram showing an example of a computation process by the evaluation metric value prediction unit 110;

FIG. 3 is an explanatory diagram showing an example of a selection process by the evaluation metric value selection unit 120;

FIG. 4 is an explanatory diagram showing an example of a conversion process by the evaluation metric value merging unit 130;

FIG. 5 is a flowchart showing the operation in the comprehensive evaluation value output processing performed by the evaluation metric value computation device 100 of the present example embodiment;

FIG. 6 is a schematic block diagram showing an example of the configuration of a computer in which the evaluation metric value computation device 100 of the present example embodiment is implemented;

FIG. 7 is a block diagram showing an outline of the evaluation metric value computation device according to the present disclosure;

FIG. 8 is an explanatory diagram showing an example of an evaluation metric defined for an entire graph representing a molecular compound and a function corresponding to the evaluation metric;

FIG. 9 is an explanatory diagram showing an example of an evaluation metric defined for an entire graph representing an ICT system and a function corresponding to the evaluation metric; and

FIG. 10 is an explanatory diagram showing an example of an evaluation metric defined for a part of a graph representing an ICT system and a function corresponding to the evaluation metric.

### DETAILED DESCRIPTION

[Description of Configuration]

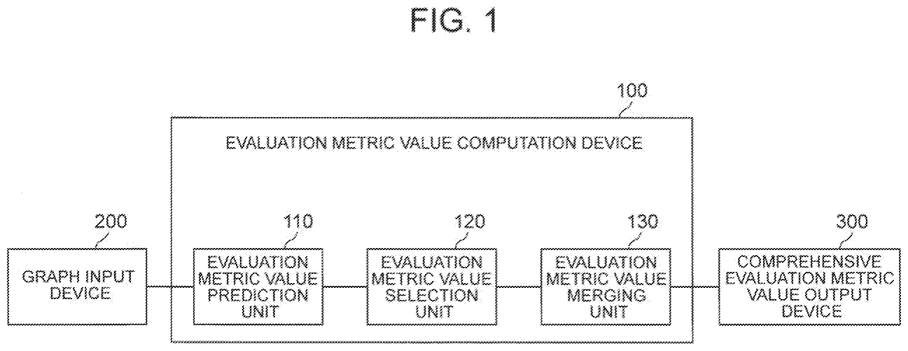

Hereinafter, an example embodiment of the present disclosure will be described with reference to the drawings. FIG. 1 is a block diagram showing an example of the configuration of an evaluation metric value computation device of an example embodiment of the present disclosure.

As mentioned above, there exists a method for exploratory optimization of a graph structure representing information represented by molecular compounds, ICT systems, etc., to satisfy a predetermined evaluation metric using a pre-trained cost function model.

The evaluation metric value computation device 100 of the present example embodiment deals with a cost function model and a learning method of the cost function model in the case where the evaluation metric, which is referred to when optimizing the structure, is given to a part of the graph structure and the evaluation metric may change with each search.

As shown in FIG. 1, the evaluation metric value computation device 100 of the present example embodiment comprises an evaluation metric value prediction unit 110, an evaluation metric value selection unit 120, and an evaluation metric value merging unit 130.

As shown in FIG. 1, the evaluation metric value prediction unit 110 is communicatively connected to the graph input device 200. As shown in FIG. 1, the evaluation metric value merging unit 130 is communicatively connected to the comprehensive evaluation metric value output device 300.

The evaluation metric value prediction unit 110 has the function of computing the value of the evaluation metric for the graph input from the graph input device 200 as a prediction value.

Specifically, the evaluation metric value prediction unit 110 receives as input a graph to which an evaluation metric is assigned. The evaluation metric value prediction unit 110 then computes, for each type of evaluation metric, the values of the evaluation metrics for the vertices and edges in the candidate of the specified range which is a range in which the evaluation metrics may be specified, among the vertices and edges constituting the input graph.

In other words, the evaluation metric value prediction unit 110 computes the values of the evaluation metrics for the candidate of the specified range in the input graph. It is noted that there may be multiple candidates of the specified range in a single graph.

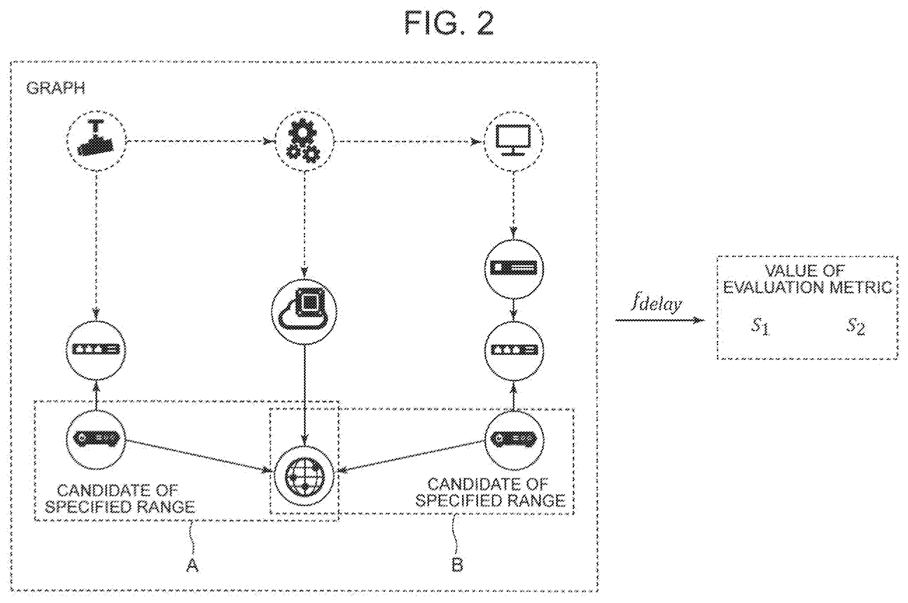

FIG. 2 is an explanatory diagram showing an example of a computation process by the evaluation metric value prediction unit 110. FIG. 2 shows the computation process for a graph in which “delay” is specified as an evaluation metric. The evaluation metric value prediction unit 110 computes the value of the evaluation metric for the input graph.

The graph enclosed by a broken line shown in FIG. 2 represents an ICT system in which “delay” is specified as an evaluation metric. The function f_{delay} shown in FIG. 2 is a function that computes the value of an evaluation metric of “delay”.

The values s₁ and s₂ of the evaluation metrics enclosed by a broken line shown in FIG. 2 are the values of the delays computed from candidates of the specified range A and B which enclose the edges that constitute the input graph, respectively.

The evaluation metric value prediction unit 110 receives the graph shown in FIG. 2 in which “delay” is specified as an evaluation metric. Next, the evaluation metric value prediction unit 110 computes respective values of delays for the candidates of the specified range A and B, which are the ranges for which “delay” may be specified as an evaluation metric, using the function f_{delay}, respectively. Next, the evaluation metric value prediction unit 110 outputs the values s₁ and s₂ of the evaluation metrics as the computation results.

The candidate of the specified range may be predefined for each type of evaluation metric. For example, the candidate of the specified range of the evaluation metric “bandwidth” may be predefined that it is set only to an edge that represents the communication corresponding to the IP layer among edges that constitute the graph representing the ICT system.

The value of the evaluation metric may consist of a plurality of values computed based on each of the plurality of evaluation metrics. The evaluation metric value prediction unit 110 may include in the computation results the value of the evaluation metric computed from at least the range specified by the evaluation metric in the graph.

The function used in the evaluation metric value prediction unit 110 can be any function as long as it is capable of computing a value of an evaluation metric. For example, the function may be a machine learning model such as a linear regression model or a graph neural network model.

When the function is a machine learning model, the machine learning model is preferably a model capable of computing a value of an evaluation metric, learned by methods such as reinforcement learning and supervised learning. The evaluation metric value prediction unit 110 may also compute a value of an evaluation metric using a simulator, actual measurement, or the like.

The evaluation metric value selection unit 120 has a function of selecting values of evaluation metrics corresponding to types of evaluation metrics specified in the input graph and a specified range from the values of evaluation metrics computed by the evaluation metric value prediction unit 110.

Specifically, the evaluation metric value selection unit 120 selects the value corresponding to the specified range which is the range in which the evaluation metric is specified in the graph input to the evaluation metric value prediction unit 110, among prediction values computed by the evaluation metric value prediction unit 110.

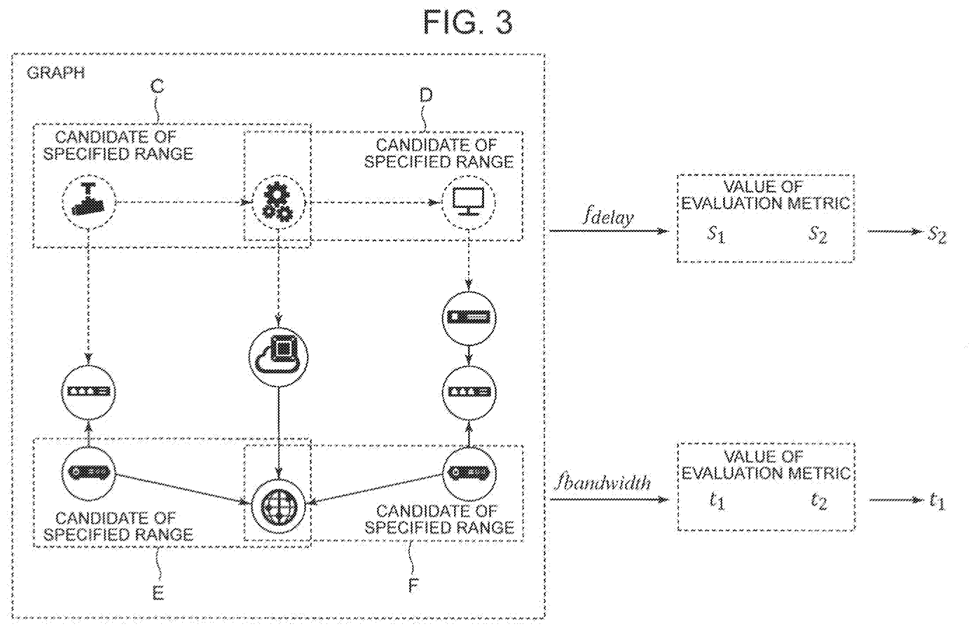

FIG. 3 is an explanatory diagram showing an example of a selection process by the evaluation metric value selection unit 120. FIG. 3 shows the selection process when a graph in which “delay” and “bandwidth” are specified as evaluation metrics is input to the evaluation metric value prediction unit 110.

The values s₁ and s₂ of evaluation metrics enclosed by a broken line shown in FIG. 3 are values of delay computed from the candidates of the specified range C and D, respectively, which are ranges in which “delay” may be specified as an evaluation metric. The evaluation metric value prediction unit 110 computes the values s₁ and s₂ of the evaluation metrics using the function f_{delay} corresponding to the type of the evaluation metric “delay,” respectively.

The values t₁ and t₂ of evaluation metrics enclosed by a broken line shown in FIG. 3 are values of bandwidth computed from the candidates of the specified range E and F, respectively, which are the ranges in which “bandwidth” may be specified as an evaluation metric. The evaluation metric value prediction unit 110 computes the values t₁ and t₂ of the evaluation metrics using the function f_{bandwidth} corresponding to the type of evaluation metric “bandwidth,” respectively.

The graphs enclosed by a broken line shown in FIG. 3 are graphs in which “delay” and “bandwidth” are specified as evaluation metrics, respectively. Specifically, the candidate of the specified range D is the specified range in which “delay” is specified as the evaluation metric. Information indicating that candidate of the specified range D is the specified range, where “delay” is specified as the evaluation metric, is added to the value s₂ of the evaluation metric.

The candidate of the specified range E is the specified range for which “bandwidth” is specified as the evaluation metric. Information indicating that the candidate of the specified range E is the specified range, where “bandwidth” is specified as the evaluation metric, is added to the value t₁ of the evaluation metric.

The evaluation metric value selection unit 120 refers to the information on the evaluation metric and the specified range, which is added to the value of the evaluation metric computed by the evaluation metric value prediction unit 110. Next, the evaluation metric value selection unit 120 selects respective values s₂ and t₁ of evaluation metrics corresponding to the candidates of the specified range D and E which are the specified ranges given for the graph shown in FIG. 3, among the values s₁, s₂, t₁ and t₂ of evaluation metrics. Next, the evaluation metric value selection unit 120 outputs the selected values of evaluation metrics.

As described above, the evaluation metric value prediction unit 110 should compute the value of evaluation metric from at least the candidate of the specified range correspond to the specified range given for the input graph among the candidates of the specified range.

The value of the evaluation metric to be selected by the evaluation metric value selection unit 120 may be predetermined. For example, the evaluation metric value selection unit 120 may select the value of the evaluation metric corresponding to the candidate of the specified range with a predetermined condition.

The evaluation metric value merging unit 130 has a function of converting values of evaluation metrics selected by the evaluation metric value selection unit 120 into a scalar value.

Specifically, the evaluation metric value merging unit 130 receives as input the prediction value of the evaluation metric selected by the evaluation metric value selection unit 120. Next, the evaluation metric value merging unit 130 outputs a single scalar value representing the comprehensive evaluation value for the graph input to the evaluation metric value prediction unit 110.

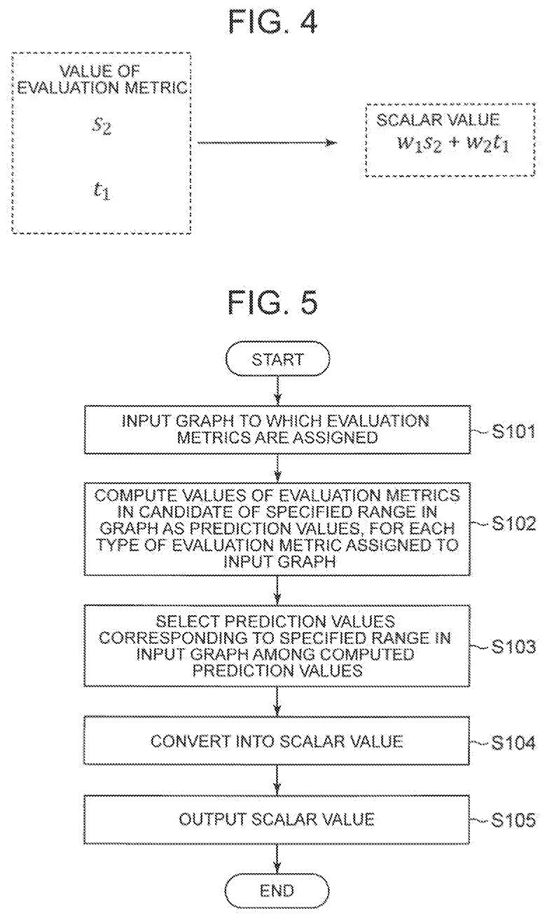

FIG. 4 is an explanatory diagram showing an example of a conversion process by the evaluation metric value merging unit 130. FIG. 4 shows a process by which the evaluation metric value merging unit 130 converts the values of evaluation metrics selected by the evaluation metric value selection unit 120 into a scalar value.

As shown in FIG. 4, the evaluation metric value merging unit 130 receives the values s₂ and t₁ of evaluation metrics as input. Then, the evaluation metric value merging unit 130 multiplies each value by a scalar value w₁ and w₂, and adds w₁s₂ and w₂t₁ together.

Next, the evaluation metric value merging unit 130 inputs the computation result value w₁s₂+w₂t₁ to the comprehensive evaluation metric value output device 300. The scalar value w₁s₂+w₂t₁ represents a linear sum of s₂ and t₁. The comprehensive evaluation metric value output device 300 outputs the input scalar value as a comprehensive evaluation value for the graph.

The conversion process to a scalar value by the evaluation metric value merging unit 130 may be any process in which the values of evaluation metrics is converted to a predetermined scalar value, even if the values of evaluation metrics are input in any order. In the conversion process by the evaluation metric value merging unit 130, a product, a maximum value, a minimum value, a mean value, a variance, etc. may be used in addition to a linear sum.

The conversion process to scalar values by the evaluation metric value merging unit 130 can be any process in which values of evaluation metrics are converted to arbitrary scalar values if the order in which they are input is fixed.

As described above, when the evaluation metric value prediction unit 110 of the present example embodiment computes one or more values of evaluation metrics in one or more ranges in which each of the evaluation metrics may be specified in a graph using a predetermined function corresponding to a type of each of the evaluation metrics, for each range, when the graph in which the evaluation metric is specified at least in part is input.

The evaluation metric value selection unit 120 of the present example embodiment selects one or more values corresponding to the range in which the evaluation metric is specified in the graph from among computed one or more values of evaluation metrics.

The evaluation metric value merging unit 130 of the present example embodiment outputs a scalar value obtained by converting the selected one or more values of evaluation metrics as a comprehensive evaluation value of the evaluation metric specified in the input graph. The evaluation metric value merging unit 130, for example, converts the multiple values of evaluation metrics into the scalar value by computing a linear sum of the selected multiple values of evaluation metrics.

The evaluation metric value prediction unit 110, the evaluation metric value selection unit 120, and the evaluation metric value merging unit 130 of the present example embodiment are realized, for example, by a CPU (Central Processing Unit) of a computer that operates according to an evaluation metric value computation program.

In the above case, the CPU reads an evaluation metric value computation program from a program recording medium such as a computer program storage device. Next, the CPU should operate as the evaluation metric value prediction unit 110, the evaluation metric value selection unit 120, and the evaluation metric value merging unit 130 according to the loaded evaluation metric value computation program.

[Description of Operation]

Hereinafter, the operation of the evaluation metric value computation device 100 of the present example embodiment will be described with reference to FIG. 5. FIG. 5 is a flowchart showing the operation in the comprehensive evaluation value output processing performed by the evaluation metric value computation device 100 of the present example embodiment.

FIG. 5 shows a process, performed by the evaluation metric value computation device 100, outputting the comprehensive evaluation value of the evaluation metrics based on the graph to which the evaluation metrics are assigned. In the following description, explanations of matters already explained will be omitted as appropriate.

First, a graph to which evaluation metrics are assigned is input from the graph input device 200 to the evaluation metric value prediction unit 110 of the evaluation metric value computation device 100 (step S101).

Next, the evaluation metric value prediction unit 110 computes values of evaluation metrics of the candidate of the specified range in the input graph as the prediction values, for each type of evaluation metric assigned to the input graph (step S102). The evaluation metric value prediction unit 110 inputs the computed prediction values to the evaluation metric value selection unit 120.

Next, the evaluation metric value selection unit 120 selects prediction values corresponding to the specified range in the graph input in step S101 among the prediction values computed in step S102 (step S103). The evaluation metric value selection unit 120 inputs the selected prediction values to the evaluation metric value merging unit 130.

Next, the evaluation metric value merging unit 130 converts the prediction values selected in step S103 into a scalar value (step S104). Next, the evaluation metric value merging unit 130 outputs the scalar value obtained by conversion in step S104 as the comprehensive evaluation value (step S105). After outputting the comprehensive evaluation value, the evaluation metric value computation device 100 ends the comprehensive evaluation value output processing.

[Description of Effects]

The evaluation metric value computation device 100 of the present example embodiment is a device that computes the comprehensive evaluation value depending on the range of search state specified by the evaluation metric and types of evaluation metrics.

The evaluation metric value computation device 100 comprises the evaluation metric value prediction unit 110 that, when a graph with an evaluation metric is input, computes values of the evaluation metrics in the range where the evaluation metric in the graph may be specified, using a learning model or the like, for each type of evaluation metric.

The evaluation metric value computation device 100 comprises the evaluation metric value selection unit 120 that selects prediction values computed according to the evaluation metric specified for the graph.

The evaluation metric value computation device 100 comprises the evaluation metric value merging unit 130 that outputs the comprehensive evaluation value of the evaluation metrics specified in the input graph by converting the values of the selected evaluation metrics into a scalar value.

The evaluation metric value computation device 100 of the present example embodiment can output a comprehensive evaluation value depending on a type of evaluation metric given to the input graph and the specified range. The reason is that the evaluation metric value prediction unit 110 can compute prediction values depending on the type of evaluation metric specified for the input graph, and the evaluation metric value selection unit 120 can select prediction values corresponding to the specified range of evaluation metrics among the computed prediction values.

The evaluation metric value computation device 100 of the present example embodiment can compute value of the changed evaluation metric even if the range of the evaluation metric or the type of the evaluation metric specified for the graph representing the molecular compound, ICT system, etc. is changed at the start of the search.

When the evaluation metric value computation device 100 is used, especially in problems where the structure of a graph representing a molecular compound, ICT system, etc. is searched in an exploratory manner, a solution based on the changed evaluation metric can be derived even if the evaluation metric referred to in the search is changed.

The following is an example of an industrial application of the present example embodiment. The evaluation metric value computation device 100 of the present example embodiment can be used for optimization of the structure of molecular compounds in the drug discovery industry. Specifically, a graph representing a molecular compound to which an evaluation metric is assigned is input to the evaluation metric value computation device 100.

The evaluation metric value prediction unit 110 uses a graph neural network as a function to compute the value of the evaluation metric, and the evaluation metric value merging unit 130 uses a linear sum for the conversion process to a scalar value, so that the evaluation metric value computation device 100 can be used to optimize the structure of molecular compounds.

In particular, the evaluation metric value computation device 100 of the present example embodiment can be applied to the problem of generating compounds in the field of drug discovery described in J. You, B. Liu, R. Ying, V. Pande, and J. Leskovec, “Graph Convolutional Policy Network for Goal-Directed Molecular Graph Generation,” Neural Information Processing Systems, 2018.

The evaluation metric value computation device 100 of the present example embodiment can also be used for the task of optimizing the structure of a graph representing an ICT system. Specifically, a graph representing an ICT system to which an evaluation metric has been assigned is input to the evaluation metric value computation device 100.

The evaluation metric value prediction unit 110 uses a graph neural network as a function to compute the value of the evaluation metric, and the evaluation metric value merging unit 130 uses a linear sum for the conversion process to a scalar value, so that the evaluation metric value computation device 100 is used to optimize the structure of the graph representing the ICT system.

In particular, the evaluation metric value computation device 100 of the present example embodiment can be applied to the search problem described in T. Maruyama, T. Kuwahara, Y. Yakuwa, T. Kuroda, and Y. Sato, “Accelerated Search for Search-Based Network Design Generation Scheme with Reinforcement Learning,” IEICE Technical Report, vol. 118, no. 483, ICM2018-71, pp. 123-128, March 2019., where multiple performance requirements are treated as evaluation metrics in addition to functional requirements.

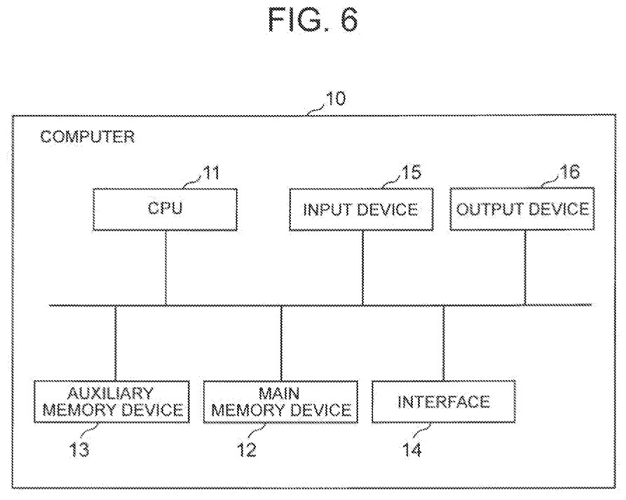

FIG. 6 is a schematic block diagram showing an example of the configuration of a computer in which the evaluation metric value computation device 100 of the present example embodiment is implemented. The computer 10 shown in FIG. 6 has a CPU 11, a main memory device 12, an auxiliary memory device 13, an interface 14, an input device 15, and an output device 16.

The evaluation metric value computation device 100 of the present example embodiment is implemented in a computer 10. The evaluation metric value computation program that realizes the operation of the evaluation metric value computation device 100 is stored in the auxiliary memory device 13.

The CPU 11 reads the evaluation metric value computation program from the auxiliary memory device 13, expands it to the main memory device 12, and executes the processes described in the above example embodiment according to the expanded evaluation metric value computation program. The main memory device 12 is, for example, RAM (Random Access Memory).

The auxiliary memory device 13 is, for example, a non-temporary tangible medium. The non-temporary tangible media include magnetic disks, optical magnetic disks, CD-ROM (Compact Disk Read Only Memory), DVD-ROM (Digital Versatile Disk Read Only Memory), semiconductor memory, etc., which are connected via the interface 14.

The input device 15 has the function of inputting data and processing instructions. The input device 15 is, for example, a keyboard or a mouse.

The output device 16 has the function to output data. The output device 16 is, for example, a display device such as a liquid crystal display device, or a printing device such as a printer.

When the evaluation metric value computation program is delivered to the computer 10 via communication lines, the computer 10 may expand the delivered program to the main memory device 12 and execute the above process.

Some or all of the components may be realized by general-purpose or dedicated circuitry, processors, or combinations of these. These may consist of a single chip or a number of chips connected via a bus. Some or all of each component may be realized by a combination of the above-mentioned circuits, etc. and programs.

When some or all of each component is realized by multiple information processing devices, circuits, etc., the multiple information processing devices, circuits, etc. may be centrally located or distributed. For example, the information processing devices, circuits, etc. may be implemented as a client-and-server system, cloud computing system, etc., each of which is connected via a communication network.

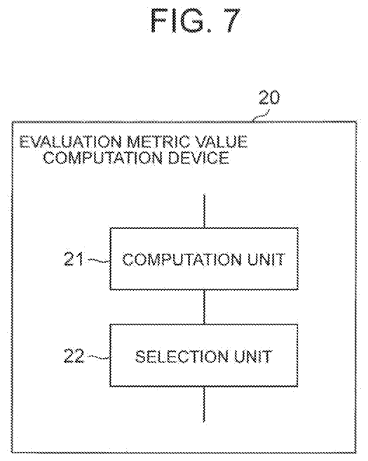

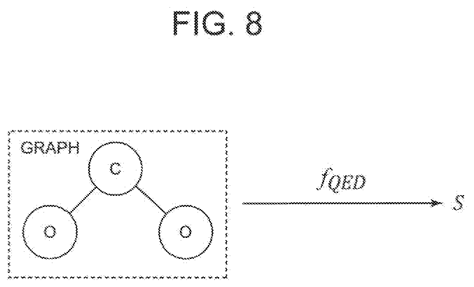

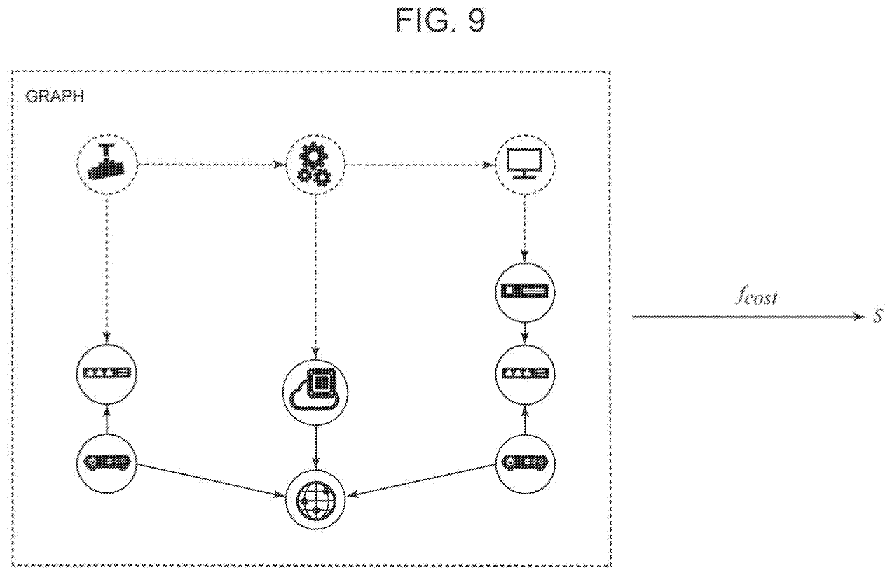

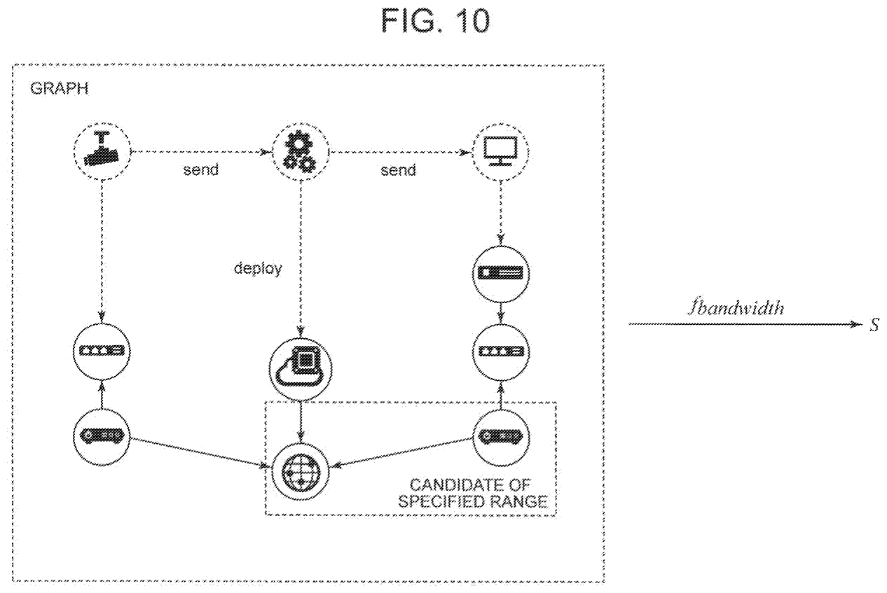

Next, an overview of the present disclosure will be explained. FIG. 7 is a block diagram showing an outline of the evaluation metric value computation device according to the present disclosure. The evaluation metric value computation device 20 according to the present disclosure includes a computation unit 21 (for example, the evaluation metric value prediction unit 110) which computes one or more values of evaluation metrics in one or more ranges (for example, candidates of the specified range) in which each of the evaluation metrics may be specified in a graph using a predetermined function corresponding to a type of each of the evaluation metrics, for each range, when the graph in which the evaluation metric is specified at least in part is input, and a selection unit 22 (for example, the evaluation metric value selection unit 120) which selects one or more values corresponding to the range (for example, the specified range) in which the evaluation metric is specified in the graph from among computed one or more values of evaluation metrics.

With such a configuration, the evaluation metric value computation device can output a comprehensive evaluation value depending on a range of a search state in which evaluation metrics are specified and a type of evaluation metric.

The evaluation metric value computation device 20 may further comprises an output unit (for example, the evaluation metric value merging unit 130) which outputs a scalar value obtained by converting the selected one or more values of evaluation metrics as a comprehensive evaluation value of the evaluation metric specified in the input graph.

The output unit may also convert the multiple values of evaluation metrics into the scalar value by computing a linear sum of the selected multiple values of evaluation metrics.

With such a configuration, the evaluation metric value computation device can output the scalar value obtained by converting values of evaluation metrics as the comprehensive evaluation value.

The predetermined function may be a learning model. The learning model may be a graph neural network.

With such a configuration, the evaluation metric value computation device can compute the value of the evaluation metric using a model that has been learned to be able to compute the value of the evaluation metric.

The graph may be a graph representing an ICT system.

With such a configuration, the evaluation metric value computation device is used for the task of optimizing the structure of the graph representing the ICT system.

While the above disclosure has been particularly shown and described with reference to example embodiments thereof, the present invention is not limited to the above disclosure. It will be understood by those of ordinary skill in the art that various changes in form and details may be made therein without departing from the spirit and scope of the present invention as defined by the claims.

What is claimed is:

1. An evaluation metric value computation device comprising:
at least one processor; and
a memory coupled to the at least one processor;
wherein the at least one processor is configured to one or more instruction to:
compute one or more values of evaluation metrics in one or more ranges in which each of the evaluation metrics may be specified in a graph using a predetermined function corresponding to a type of each of the evaluation metrics, for each range, when the graph in which the evaluation metric is specified at least in part is input, and
select one or more values corresponding to the range in which the evaluation metric is specified in the graph from among computed one or more values of evaluation metrics.

2. The evaluation metric value computation device according to claim 1, wherein the at least one processor is further configured to one or more instruction to:
output a scalar value obtained by converting the selected one or more values of evaluation metrics as a comprehensive evaluation value of the evaluation metric specified in the input graph.

3. The evaluation metric value computation device according to claim 2, wherein the at least one processor is configured to one or more instruction to:
convert the multiple values of evaluation metrics into the scalar value by computing a linear sum of the selected multiple values of evaluation metrics.

4. The evaluation metric value computation device according to claim 1, wherein
the predetermined function is a learning model.

5. The evaluation metric value computation device according to claim 2, wherein
the predetermined function is a learning model.

6. The evaluation metric value computation device according to claim 3, wherein
the predetermined function is a learning model.

7. The evaluation metric value computation device according to claim 4, wherein
the learning model is a graph neural network.

8. The evaluation metric value computation device according to claim 5, wherein
the learning model is a graph neural network.

9. The evaluation metric value computation device according to claim 6, wherein
the learning model is a graph neural network.

10. The evaluation metric value computation device according to claim 1, wherein
the graph represents an Information and Communication Technology system.

11. The evaluation metric value computation device according to claim 2, wherein
the graph represents an Information and Communication Technology system.

12. The evaluation metric value computation device according to claim 3, wherein
the graph represents an Information and Communication Technology system.

13. The evaluation metric value computation device according to claim 4, wherein
the graph represents an Information and Communication Technology system.

14. The evaluation metric value computation device according to claim 5, wherein
the graph represents an Information and Communication Technology system.

15. The evaluation metric value computation device according to claim 6, wherein
the graph represents an Information and Communication Technology system.

16. The evaluation metric value computation device according to claim 7, wherein
the graph represents an Information and Communication Technology system.

17. An evaluation metric value computation method comprising:
computing one or more values of evaluation metrics in one or more ranges in which each of the evaluation metrics may be specified in a graph using a predetermined function corresponding to a type of each of the evaluation metrics, for each range, when the graph in which the evaluation metric is specified at least in part is input, and
selecting one or more values corresponding to the range in which the evaluation metric is specified in the graph from among computed one or more values of evaluation metrics.

18. The evaluation metric value computation method according to claim 17, further comprising:
outputting a scalar value obtained by converting the selected one or more values of evaluation metrics as a comprehensive evaluation value of the evaluation metric specified in the input graph.

19. A non-transitory computer readable information recording medium storing an evaluation metric value computation program, when executed by a computer, performs:
computing one or more values of evaluation metrics in one or more ranges in which each of the evaluation metrics may be specified in a graph using a predetermined function corresponding to a type of each of the evaluation metrics, for each range, when the graph in which the evaluation metric is specified at least in part is input, and
selecting one or more values corresponding to the range in which the evaluation metric is specified in the graph from among computed one or more values of evaluation metrics.

20. The non-transitory computer readable information recording medium according to claim 19, wherein
the evaluation metric value computation program, when executed by a computer, further performs:
outputting a scalar value obtained by converting the selected one or more values of evaluation metrics as a comprehensive evaluation value of the evaluation metric specified in the input graph.
